(19) United States
(12) Patent Application Publication
(10) Pub. No.: US 2026/0154635 A1
(43) Pub. Date: Jun. 4, 2026

(54) CONSTRUCTION BUDGET LIFECYCLE MANAGEMENT SYSTEM

(71) Applicant: BUILDR, LLC, Orange, CA (US)

(72) Inventors: Michael Anthony Stock, II, Huntington Beach, CA (US); Gerard Edward Gonzalez, Huntington Beach, CA (US); Matthew Vincent Casper, El Cajon, CA (US); Vincent Giovanni Dibernardo, Los Angeles, CA (US)

(73) Assignee: BUILDR, LLC, Orange, CA (US)

(21) Appl. No.: 19/409,719

(22) Filed: Dec. 4, 2025

Related U.S. Application Data
(60) Provisional application No. 63/728,155, filed on Dec. 4, 2024.

(51) Int. Cl. G06Q 10/0631; G06F 40/197

(52) U.S. Cl. CPC G06Q 10/06313; G06F 40/197

(57) ABSTRACT

A method may include initializing a budget in a budget software. The budget may include at least one line item. The method may also include generating a snapshot of the budget and providing the snapshot to the user device in response to a user input from a user device. The method may further include obtaining, from the user device, the snapshot that includes a first revision to the at least one line item of the budget. The method may also include determining a conflict between the first revision and a second revision. The method may further include updating the budget in the budget software based one of the first revision and the second revision in response to a second user input. The method may also include providing the updated budget to the user device.

### CROSS REFERENCE TO RELATED APPLICATIONS

This U.S. Patent Application claims priority to U.S. Provisional Patent Application No. 63/728,155, titled “BUDGETING VERSION CONTROLLED PATENT,” and filed on Dec. 4, 2024, the disclosure of which is hereby incorporated by reference in its entirety.

### TECHNICAL FIELD

This disclosure generally relates to budget management, and more specifically, to a construction budget lifecycle management system.

### BACKGROUND

Unless otherwise indicated herein, the materials described herein are not prior art to the claims in the present application and are not admitted to be prior art by inclusion in this section.

Managing a construction budget may take a significant amount of time. In some instances, multiple people associated with a project that includes a budget may contribute to management of the budget, which may introduce inconsistencies within the budget and/or limit editing of the budget to a sequential operation. Further, budget management may be prone to errors due to the various changes and determining when an error may have been introduced and by whom may further complicate the budget management.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, a system may include one or more non-transitory computer-readable storage media that may be configured to store instructions. The system may also include one or more processors that may be communicatively coupled to the one or more non-transitory computer-readable storage media. The one or more processors may be configured to cause the system to perform operations in response to execution of the instructions. The operations may include initializing a budget in a budget software. The budget may include at least one line item. The operations may also include generating a snapshot of the budget and providing the snapshot to the user device. The operations may further include obtaining the snapshot that may include a first revision to the at least one line item of the budget from the user device. The operations may also include determining a conflict between the first revision and a second revision. The operations may further include updating the budget in the budget software based one of the first revision and the second revision. The updating the budget may be in response to a second user input. The operations may also include providing the updated budget to the user device.

In another embodiment, a method may include initializing a budget in a budget software. The budget may include at least one line item. The method may also include generating a snapshot of the budget and providing the snapshot to the user device in response to a user input from a user device. The method may further include obtaining, from the user device, the snapshot that includes a first revision to the at least one line item of the budget. The method may also include determining a conflict between the first revision and a second revision. The method may further include updating the budget in the budget software based one of the first revision and the second revision in response to a second user input. The method may also include providing the updated budget to the user device.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates an example system for construction budget lifecycle management;

FIG. 2 illustrates a diagram of an example budget management flow;

FIG. 3 illustrates a flowchart of an example method using a construction budget lifecycle management system; and

FIG. 4 illustrates an example computing device.

### DETAILED DESCRIPTION

A construction budget is a detailed plan that may outline individual costs associated with a construction project. In many cases, a construction budget may include many individual line items, which may be grouped together, to represent different types of costs that may be associated with the construction project. In many approaches, the construction budget may be generated and/or maintained in spreadsheets or similar software, which may be error prone and/or may limit collaboration between different entities associated with the construction project.

Aspects of the present disclosure address these and other limitations by providing a budget software that manages a budget corresponding to a project in a repository-like data structure. As such, the budget software may maintain a record of any and all changes that may be made to the budget over the lifecycle of the budget and/or the project. Further, the budget software may allow collaboration of multiple users to modify the budget, while providing a mechanism to resolve conflicts that may arise due to multiple users modifying the budget.

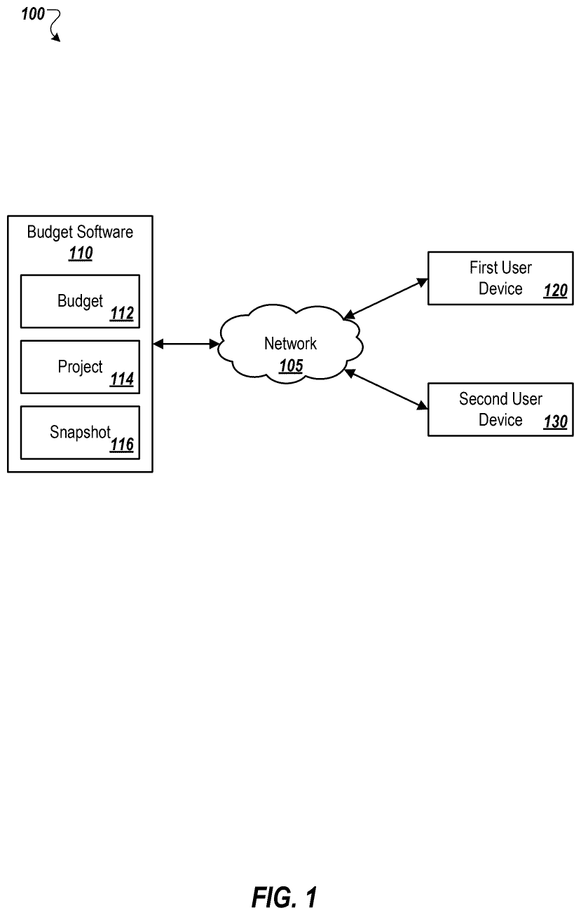

FIG. 1 illustrates an example system 100 for construction budget lifecycle management. The system 100 may include a network 105, a budget software 110, a first user device 120, and a second user device 130. The budget software 110 may include a budget 112, a project 114, and a snapshot 116.

In some instances, the network 105 may be a wired and/or a wireless network that may facilitate communications and/or data transfers between connected devices, such as the budget software 110, the first user device 120, and/or the second user device 130. For example, the network 105 may include one or more of an Ethernet, a fiber optic, a coaxial, a wireless local area network, a wireless metropolitan area network, a wireless personal area network, and/or any other type of network. Alternatively, or additionally, the network 105 may include the internet and may provide cloud-based networking capabilities.

The first user device 120 and/or the second user device 130 may be a personal device for use by a user to interact with the budget software 110 via the network 105. For example, the first user device 120 and/or the second user device 130 may include one or more of a personal computer, a laptop computer, tablet computer, a mobile phone, and/or any other similar device that may be used to communicate with other devices via the network 105.

In some instances, the budget software 110 may be used to initialize, modify, store, and/or provide version control to the budget 112, as described herein. In some instances, the budget software 110 may be an immutable data structure, such that any operation taken with respect to the budget 112 may be recorded. For example, after the budget 112 has been established, a modification entered by a user may be recorded and/or tracked with respect to the budget 112 such that the modification may be viewed at any time thereafter. In some instances, any change to the budget 112 may be captured as a new entry, such that any instance in the budget 112 may be tracked and/or referenced at a later point in time. In such arrangement, any aspect of the budget 112 (e.g., the line items) may be able to be referenced. Stated another way, any entries in the budget 112 may not be changed, but rather may be captured as a new entry to the budget 112, such that any event with respect to the budget 112 may be stored and/or referenced.

In some instances, the version control associated with the budget 112 may provide a timing associated with a modification to the budget 112. For example, in instances in which the budget 112 is modified at a first time, at any time thereafter, a user may examine the budget 112 and identify the first time in which the modification was made to the budget 112. Alternatively, or additionally, the version control may provide a description of the modification to the budget 112. For example, the budget software 110 may record a description associated with the modification and the description of the modification of the budget 112 may be viewed at any time thereafter. Alternatively, or additionally, the version control may provide a user associated with the modification to the budget 112. For example, in instances in which a first user makes a modification to the budget 112, a second user may be able to view, using the budget software 110, that the modification was made by the first user.

In some instances, the budget 112 may include one or more line items. Each of the line items within the budget 112 may be individually coded, such that each of the line items may be included in the immutable data structure associated with the budget software 110. In some instances, the line items may be associated with a project, which may be associated with the budget 112. For example, a user may use the budget software 110 to create a project and initialize the budget 112 associated with the project. As such, each line item included in the budget 112 may pertain to one or more aspects of the project. For example, a project may be a home construction, the line items associated with the project may include concrete costs, lumber costs, building permits, etc. (some of which may be subdivided further, as desired), and the budget 112 may be a total of the line items associated with the project.

In some instances, the line items may be grouped (e.g., arranged) by a category, which may support rolling up the costs associated with the line items. The categories may include at least one of a direct cost, an indirect cost, and/or an overhead cost (or markup cost). For example, three line items that may be included in the budget 112 may be categorized as direct costs and the three line items may be rolled together and displayed in the budget software 110.

Alternatively, or additionally, the line items may include one or more characteristics that may include additional information about the line items. In some instances, the characteristics may include a line item code, a quantity, a total cost, a cost per unit, and/or a formula. The characteristics of the line items may contribute additional information associated with the corresponding line items, and/or one or more of the characteristics may be used in determining the characteristics. For example, a user may have entered a cost per unit for a particular line item, and in response to a user entering a number of units for the particular line item, the budget software 110 may automatically determine the total cost for the particular line item.

In some instances, a user of the first user device 120 or the second user device 130 may seek to make revisions to the budget 112. In such instances, the user may submit a request from the first user device 120 to the budget software 110 to make one or more revisions to the budget 112. In such instances, the budget software 110 may generate the snapshot 116 which may be a representation of the budget 112 at the time the request may have been received. The user may make any number of revisions to the snapshot 116, including adding line items, removing line items, and/or modifying line items. In some instances, the snapshot 116 may be stored as a local file on the first user device 120.

Upon completion of the revisions, the budget software 110 may obtain the snapshot 116 that includes the revisions from the user of the first user device 120. In some instances, the budget software 110 may provide a visual indicator to the user of the revisions relative to the budget 112. For example, added line items may include a green and/or ‘+’ indicator; removed line items may include a red and/or ‘−’ indicator; and/or modified line items may include a yellow and/or ‘o’ indicator. Alternatively, or additionally, the budget software 110 may generate a notification to the user that the revisions included in the snapshot 116 may conflict with one or more other revisions to the budget 112. In such instances, the budget software 110 may cause the user submitting the snapshot 116 to resolve the conflict prior to accepting the snapshot 116 and the revisions included therein into the budget 112.

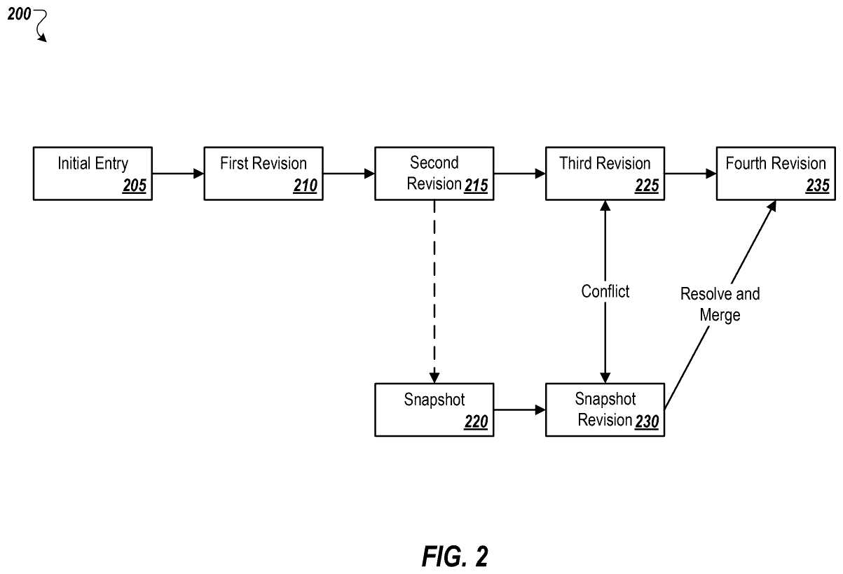

In some instances, the conflict may be caused when the snapshot 116, which includes one or more revisions, may be obtained by the budget software 110 and a second snapshot may have already caused changes to one or more line items in the budget 112. Alternatively, or additionally, the conflict may be caused when the snapshot 116 may be obtained by the budget software 110 and modifications may have been made directly to the budget 112 (e.g., without generating and modifying a snapshot). In these and other instances, the user submitting the snapshot 116 may be prompted with a notification to resolve the conflict prior to the budget 112 being updated in view of the snapshot 116. For example, the budget software 110 may request the user select a first new line item from the snapshot 116 or a second new line item already included in the budget 112 before accepting any of the revisions included in the snapshot 116. FIG. 2 may further illustrate and describe the budget 112, the snapshot 116, revisions, and/or conflict resolution.

In these and other instances, the budget software 110 may maintain a record (or version history) of any modifications made to the budget 112 at any time subsequent to the initialization of the budget 112. The record may include any changes to any of the line items at any point in time. For example, the record may include an initial entry of a first line item at a first time, a subsequent modification of the first line item by a first user at a second time, a second modification of the first line item by a second user at a third time, and so forth. In some instances, the budget software 110 may facilitate comparing the budget 112 between a first instance in time and a second instance in time, which may illustrate how the budget 112 may have changed in time. Alternatively, or additionally, in instances in which the budget software 110 includes more than one budget 112 and/or more than one project, the budget software 110 may be operable to provide a comparison between multiple budgets. In such instances, the budget software 110 may allow a user to compare different budgets and/or budgets associated with different projects, such as to view how budgets may change between similar projects.

In some instances, the budget software 110 may provide a visual indication, such as a graph, to illustrate how the budget 112 may change in time. For example, the graph of the budget 112 (or the line items thereof) may vary as modifications are made to the budget 112 to illustrate increases or decreases to the budget 112 over time. In some instances, the budget software 110 may allow a user thereof to add tags to the budget 112. The tags may correspond to milestones associated with the budget 112 and/or the project. Alternatively, or additionally, a user may add one or more tags to the budget 112 and/or line items of the budget 112 to provide information to other users associated with the budget 112, such as considerations for a line item calculation, maximum or minimum values for a particular line item, etc. In some instances, the tags and/or milestones may be visually displayed by the budget software 110, such as included in the graph provided in the budget software 110.

In some instances, the budget software 110 may include an artificial intelligence (AI) module that may be operable to interact with users and/or perform operations within the budget software 110. In some instances, the AI module may use as a reference historical budgets that may be included in the budget software 110, context associated with the budget 112, such as provided by a user upon initialization of the budget 112, and/or access to public information (e.g., information available on the internet that may be applicable to the budget 112). In some instances, the AI module may be operable to receive queries from the first user device 120 and/or the second user device 130 and may perform operations in response to the queries. For example, the AI module may provide an estimate of a particular line item in response to a query based on a historical budget and/or information obtained from the internet. In another example, the AI module may generate a line item in response to a query to generate a line item based on a line item from a historical budget. In some instances, the AI module may be operable to determine and/or generate a report associated with a comparison of the budget 112 at two instances in time. For example, a query to the AI module may request a summary of modifications to the budget 112 from a first time to a second time, including the user that made the modifications and/or if any tags were applied to describe the modifications.

Modifications, additions, or omissions may be made to the system 100 without departing from the scope of the present disclosure. For example, the designations of different elements in the manner described is meant to help explain concepts described herein and is not limiting. Further, the system 100 may include any number of other elements or may be implemented within other systems or contexts than those described. For example, any of the components of FIG. 1 may be divided into additional or combined into fewer components.

FIG. 2 illustrates a diagram of an example budget management flow 200. The flow 200 may begin with an initial entry 205 to a budget, such as the budget 112 of FIG. 1. As described herein, entries and/or revisions to the budget (or a snapshot) may include additions, removals, and/or modifications to the budget and/or line items included in the budget. In some instances, the initial entry 205 may include at least a modified date (e.g., the date and/or time when the initial entry 205 was made to the budget) and/or a modifying user (e.g., the user that entered the initial entry 205 to the budget) attributed to the initial entry 205. For example, on a first date, a first user may generate the initial entry 205 for the budget.

At a time subsequent to the initial entry 205, a first revision 210 may be made to the budget. The first revision 210 may include any change to the budget, such as a new line item, a removed line item, and/or a modified line item. In some instances, the first revision 210 may include a modified date and/or a modifying user. In some instances, the modifying user associated with the first revision 210 may be the same or may differ from the modifying user associated with the initial entry 205. Continuing the example, on a second date (subsequent to the first date), a second user may generate the first revision 210 that may be included in the budget.

At a time subsequent to the first revision 210, a second revision 215 may be made to the budget. Like the first revision 210, the second revision may include any change to the budget. In some instances, the modifying user associated with the second revision 215 may be the same or may differ from the modifying user associated with the initial entry 205 and/or the first revision 210. Continuing the example, on a third date (subsequent to the first date and the second date), the first user may generate the second revision 215 that may be included in the budget.

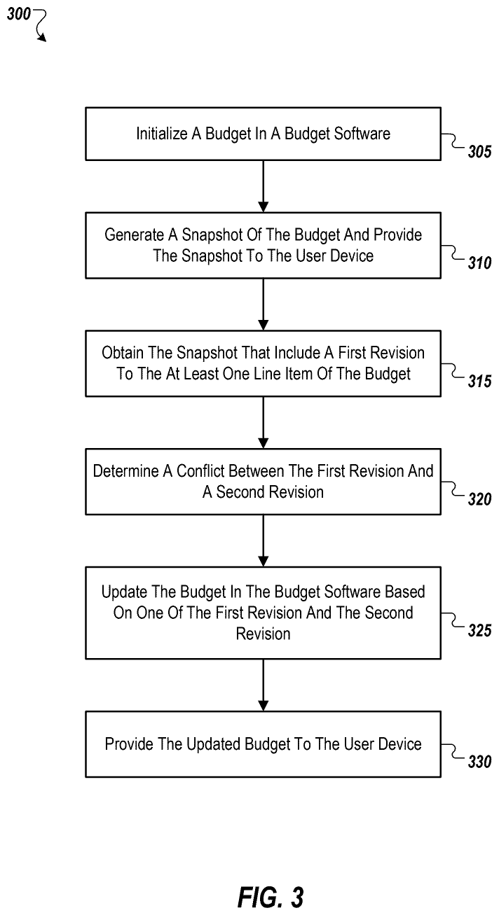

In instances in which a snapshot 220 is obtained from the budget, the snapshot 220 may be representative of the budget at which time the snapshot 220 may have been obtained. As illustrated in FIG. 3, the snapshot 220 may be the same as the budget at the time the second revision 215 may have been made to the budget. In some instances, the snapshot 220 may be obtained by a user that may want to prepare modifications to the budget without actually making the changes to the budget. For example, changes made to the snapshot 220 may not be reflected in the budget until the snapshot 220 may be merged into the budget.

A third revision 225 may be made subsequent to the second revision 215. In some instances, a snapshot revision 230 may be made at a similar time as the third revision 225, and may be made by a different user. For example, the first user may be responsible for the third revision 225, and the second user may be responsible for the snapshot revision 230. As illustrated, the third revision 225 may be and entered in the budget while the snapshot revision 230 may not be included in the budget (e.g., may be retained remote from the budget, and therefore, not tracked relative to the budget). In some instances, both the third revision 225 and the snapshot revision 230 may be made at a moment in time after the second revision 215, while the third revision 225 may be made before, after, or at the same time as the snapshot revision 230. In these and other instances, the third revision 225 and the snapshot revision 230 may include different changes to the budget, such that there may be a conflict if both the third revision 225 and the snapshot revision 230 were to be included in the budget at the same time. For example, the third revision 225 may include modifications to a first line item and the snapshot revision 230 may include different changes to the first line item and/or changes to a second line item.

In instances in which a conflict is present, the user (e.g., the user responsible for the snapshot revision 230, or the second user in the examples) associated with the snapshot revision 230 may be prompted by budget software (e.g., responsible for maintaining the budget, such as the budget software 110 of FIG. 1) to resolve the conflict prior to accepting the snapshot revision 230 into the budget. For example, the budget software may indicate the a first line item was changed to a first metric in the third revision 225 and the first line item has a second metric in the snapshot revision 230, and the user may select which one to be included in the budget. In response to the user resolving the conflict, a fourth revision 235 may be captured in the budget, which may include the modifications associated with the snapshot revision 230 and/or the third revision 225, and in accordance with the resolution to the identified conflicts.

As such, the budget software, as described relative to the flow 200, may maintain a record of any change made to the budget and/or may facilitate collaboration between multiple users. The collaboration may include a user making changes to a snapshot of the budget reconciling conflicts before having the snapshot included in the budget.

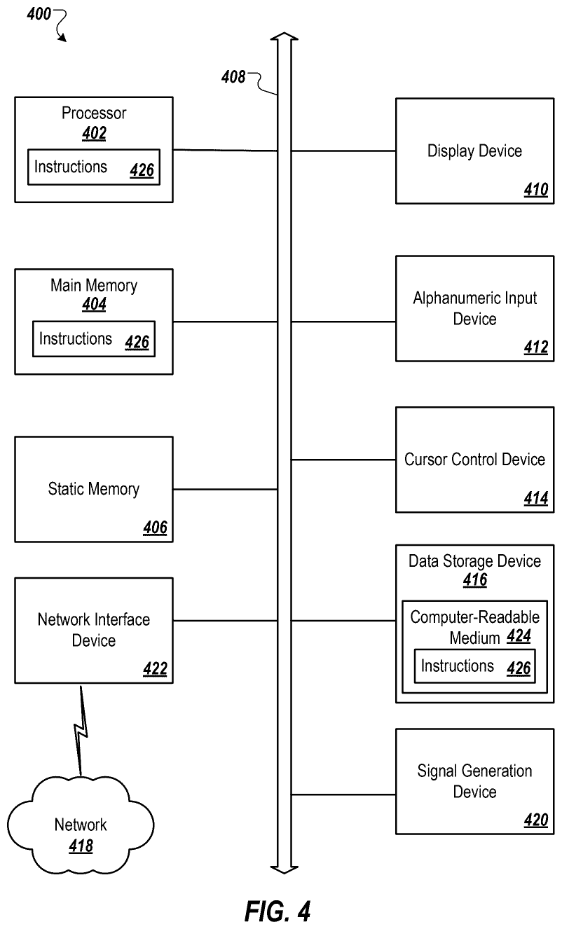

FIG. 3 illustrates a flowchart of an example method 300 using a construction budget lifecycle management system. The method 300 may be performed by processing logic that may include hardware (circuitry, dedicated logic, etc.), software (such as is run on a general purpose computer system or a dedicated machine), or a combination of both, which processing logic may be included in any computer system or device such as the budget software 110, the first user device 120, or the second user device 130 of FIG. 1, and/or the processing device 402 of FIG. 4.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

The method 300 may begin at block 305 where processing logic may initialize a budget in a budget software. In some instances, the budget may include at least one line item. In some instances, the budget software may provide a version control of the budget. The version control may include one or more of a timing associated with a modification, a description of the modification, and/or a user associated with the modification to the budget.

In some instances, the budget may be stored as an immutable data structure. In some instances, the one line item may be associated with a project. In some instances, the one line item may include one or more characteristics that may be grouped by a category. Further, the category may be one of a direct cost, an indirect cost, or an overhead cost. Alternatively, or additionally, the characteristics may include one or more of a line item code, a quantity, a cost, and a formula.

At block 310, the processing logic may generate a snapshot of the budget and may provide the snapshot to the user device. In some instances, the snapshot may be generated in response to a user input from a user device.

At block 315, the processing logic may obtain the snapshot that may include a first revision to the one line item of the budget. In some instances, the snapshot with revisions may be obtained from the user device.

At block 320, the processing logic may determine a conflict between the first revision and a second revision. In some instances, the second revision may be obtained from a second snapshot or from a budget edit to the budget.

At block 325, the processing logic may update the budget in the budget software based on one of the first revision and the second revision. At block 330, the processing logic may provide the updated budget to the user device.

Modifications, additions, or omissions may be made to the method 300 without departing from the scope of the present disclosure. For example, the processing logic may further provide a visual indicator that may correspond to the one line item in the budget software based on the first revision.

In another example, the processing logic may further obtain the budget at a first instance in time and a second instance in time. The processing logic may also determine one or more modifications to the budget from the first instance in time and the second instance in time. The processing logic may also provide the modifications to the user device.

In another example, the designations of different elements in the manner described is meant to help explain concepts described herein and is not limiting. Further, the method 300 may include any number of other elements or may be implemented within other systems or contexts than those described.

FIG. 4 illustrates an example computing device 400 within which a set of instructions, for causing the machine to perform any one or more of the methods discussed herein, may be executed. The computing device 400 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 400 includes a processing device 402 (e.g., a processor), a main memory 404 (e.g., read-only memory (ROM), flash memory, dynamic random access memory (DRAM) such as synchronous DRAM (SDRAM)), a static memory 406 (e.g., flash memory, static random access memory (SRAM)) and a data storage device 416, which communicate with each other via a bus 408.

The processing device 402 represents one or more general-purpose processing devices such as a microprocessor, central processing unit, or the like. More particularly, the processing device 402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 402 may also include one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein.

The computing device 400 may further include a network interface device 422 which may communicate with a network 418. The computing device 400 also may include a display device 410 (e.g., a liquid crystal display (LCD) or a cathode ray tube (CRT)), an alphanumeric input device 412 (e.g., a keyboard), a cursor control device 414 (e.g., a mouse) and a signal generation device 420 (e.g., a speaker). In at least one implementation, the display device 410, the alphanumeric input device 412, and the cursor control device 414 may be combined into a single component or device (e.g., an LCD touch screen).

The data storage device 416 may include a computer-readable storage medium 424 on which is stored one or more sets of instructions 426 embodying any one or more of the methods or functions described herein. The instructions 426 may also reside, completely or at least partially, within the main memory 404 and/or within the processing device 402 during execution thereof by the computing device 400, the main memory 404 and the processing device 402 also constituting computer-readable media. The instructions may further be transmitted or received over the network 418 via the network interface device 422.

While the computer-readable storage medium 424 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. A system, comprising:
one or more non-transitory computer-readable storage media configured to store instructions; and
one or more processors communicatively coupled to the one or more non-transitory computer-readable storage media and configured to, in response to execution of the instructions, cause the system to perform operations, the operations comprising:
initialize a budget in a budget software, the budget comprising at least one line item;
in response to a user input from a user device, generate a snapshot of the budget and provide the snapshot to the user device;
obtain, from the user device, the snapshot that comprises a first revision to the at least one line item of the budget;
determine a conflict between the first revision and a second revision;
in response to a second user input, update the budget in the budget software based one of the first revision and the second revision; and
provide the updated budget to the user device.

2. The system of claim 1, further comprising provide, in the budget software, a version control of the budget.

3. The system of claim 2, wherein the version control provides one or more of a timing associated with a modification, a description of the modification, and a user associated with the modification to the budget.

4. The system of claim 1, further comprising provide a visual indicator corresponding to the at least one line item in the budget software based on the first revision.

5. The system of claim 1, wherein the budget is stored as an immutable data structure.

6. The system of claim 1, wherein the at least one line item is associated with a project.

7. The system of claim 6, wherein the budget is associated with a project entered into the budget software.

8. The system of claim 1, wherein the at least one line item comprises one or more characteristics that are grouped by a category.

9. The system of claim 8, wherein the category is one of a direct cost, an indirect cost, or an overhead cost.

10. The system of claim 8, wherein the characteristics comprise one or more of a line item code, a quantity, a cost, and a formula.

11. The system of claim 1, wherein the second revision is obtained from a second snapshot or from a budget edit to the budget.

12. The system of claim 1, further comprising:
obtain the budget at a first instance in time and a second instance in time;
determine one or more modifications to the budget from the first instance in time and the second instance in time; and
provide the modifications to the user device.

13. A method, comprising:
initializing a budget in a budget software, the budget comprising at least one line item;
in response to a user input from a user device, generating a snapshot of the budget and providing the snapshot to the user device;
obtaining, from the user device, the snapshot that comprises a first revision to the at least one line item of the budget;
determining a conflict between the first revision and a second revision;
in response to a second user input, updating the budget in the budget software based one of the first revision and the second revision; and
providing the updated budget to the user device.

14. The method of claim 13, wherein the budget software provides a version control of the budget, and the version control comprises one or more of a timing associated with a modification, a description of the modification, and a user associated with the modification to the budget.

15. The method of claim 13, further comprising providing a visual indicator corresponding to the at least one line item in the budget software based on the first revision.

16. The method of claim 13, wherein the budget is stored as an immutable data structure.

17. The method of claim 13, wherein the at least one line item is associated with a project.

18. The method of claim 13, wherein:
the at least one line item comprises one or more characteristics that are grouped by a category;
the category is one of a direct cost, an indirect cost, or an overhead cost; and
the characteristics comprise one or more of a line item code, a quantity, a cost, and a formula.

19. The method of claim 13, wherein the second revision is obtained from a second snapshot or from a budget edit to the budget.

20. The method of claim 13, further comprising:
obtaining the budget at a first instance in time and a second instance in time;
determining one or more modifications to the budget from the first instance in time and the second instance in time; and
providing the modifications to the user device.
